(19) United States
(12) Patent Application Publication
(10) Pub. No.: US 2002/0046638 A1
(43) Pub. Date: Apr. 25, 2002

(54) Interactive music, teaching system, method and system

(76) Inventors: Glenda Wright, Las Vegas, NV (US); Stephen Turner, Las Vegas, NV (US)

Correspondence Address: Anderson & Morishita, L.L.C., Suite 127, 3311 S. Rainbow, Las Vegas, NV, 89146, US

(21) Appl. No.: 09/911,755

(22) Filed: Jul. 23, 2001

Related U.S. Application Data
(60) Provisional application No. 60/221,536, filed on Jul. 28, 2000.

(51) Int. Cl. G09B 15/02

(52) U.S. Cl. 84/477 R; 84/612

(57) ABSTRACT

An interactive system for accessing, performing and transmitting music which includes a display, computer processor and a local or remote data structure containing data corresponding to music score, tutorial information, a sample performance of the music, accompaniment, video and other data. With a controller the user accesses that data structure and displays selected data for the files stored in the data structure. The user may also manipulate the tempo, key, fingering or other aspects of the music. The data may be stored at one or more remote servers and accessed by the user through the Internet.

### CROSS REFERENCE TO RELATED APPLICATION

This application is a utility application filing for provisional patent application Ser. No.: 60/221,536 filed Jul. 28, 2000 and titled “Interactive Music Teaching System Method and Apparatus”

### FIELD OF THE INVENTION

The present invention relates to devices, systems and method for retrieving music stored in local or remote data structures for display for performance of the music. The present invention also relates to systems and methods for musically interacting with remote musicians and for storing performances.

### BACKGROUND

It is known to provide an electronic piano which includes a touch sensitive display such as described in Koevering, U.S. Pat. No. 5,864,078. In this patent the piano has a touch screen display formed as part of the music stand. From compact discs, music can be displayed at the display for user to play the piano from.

A drawback with the piano of Koevering is that it is not interactive and the approach is not well suited to other musical instruments or music stands which do not have a built-in video display.

The object of the present invention is to provide a display which has the following features: it can be placed upon a piano or other music stand to provide the benefits thereof for a person playing any type of musical instrument, as well as for voice training; is interactive in that the music, score, tutorial and educational materials, including music, text, performances, practice materials, and the like, can be sent and received to and from the display to memory devices, such as connected computers, data storage devices, such as floppy discs, compact discs, or other media, as well as over the Internet; can display and send performances for entertainment as well as educational purposes; can edit score for the student or composer; can provide for real time tutoring from a remote location; can be controlled to play a selected music piece for entertainment or for educating the student with respect to how the piece, when played correctly, should sound; and can display score and control a sound system to play accompanying orchestral or ensemble so the student can play the piece with accompaniment.

### SUMMARY OF THE INVENTION

Toward this end the present invention is directed to a system which provides access to music score for performance, which provides for modification of the score for purposes of performance and education, which can provide audio accompaniment as well as tutorial lessons as well as other features and advantages.

In one embodiment directed to any musical instrument or for voice performance/tutoring, an interactive system for providing for musical training and performance is provided which includes a display for displaying musical score, lyrics, tutorial or text messages and a controlling processor. The processor may be a personal computer or dedicated processor. A data structure store a plurality of music composition data files including at least music but which may include lyrics, tutorial or historical information as well as data representing actual performance of the piece (for example by a professional musician) for playback by the user to listen to a professional performance of the work. Preferably each of stored files are adapted to be modified to change at least the tempo and key. The data structure may be removable storage media such as discs, compact discs, digital video discs or other computer readable media. Further the data structure may be stored at a remote location linked to the processor over a telecommunications link such as the world wide web (Internet). In this instance there may be a plurality of remote computer servers storing, for example, selected data for downloading (free or for a fee). A controller is also provided for the user to control the processor to access a selected file in the data structure and to display the same at the display. Thus the user may, through the Internet or from other computer readable media, access a Bach musical piece and display the score at the display for performance thereof. The controller further includes means to modify the displayed data for at least one of changing said tempo and key and for scrolling the display, e.g. turning pages, to display said musical file. In addition to the musical score the display may also display tutorial or historical information for the work for the enjoyment and education of the user. Still further with the controller the user may also access and broadcast accompaniment data for the piece. For example, for a Beethoven piano concerto, the user would display the piano part and the orchestral accompaniment be broadcast from system speakers.

Other features include microphones and digital cameras for users to link to perform works and visually see and record performances.

The data may be in the form of performance related data or tutorial data whereby users may receive instruction from a remote teacher or a prominent instructor may access and instruct remote and greater numbers of pupils.

Where the user has means to enter music data such as an electronic keyboard, the system and method permits remote storage and transmission of the music.

### BRIEF DESCRIPTION OF THE DRAWINGS

These and other features and advantages will become better appreciated when the same becomes better understood with reference to the description, claims and drawings where:

FIG. 1 illustrates the system and method of the present invention shown for use with a piano;

FIG. 2 illustrates an example of a keypad for control of the system;

FIG. 3 illustrates, for example, a conductors podium including the present invention;

FIG. 4 shows a slide-out tray mounting data entry means according to the present invention; and

FIG. 5 is an illustration of a laptop computer configured with a keyboard.

### DESCRIPTION

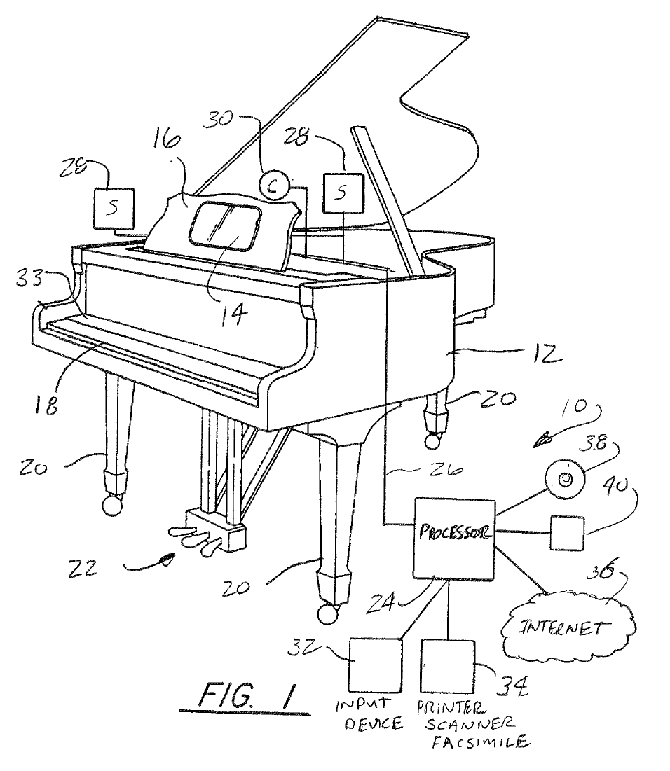

Turning to the drawing, FIG. 1 shows the system 10 and method of the present invention for use with a piano 12. While the following description is directed to the system 10 for use with the piano 12, it should be understood that the invention could be used with any musical instrument including electronic keyboards, brass, string, woodwind or percussion instruments or for voice training.

The system 10 includes a video display 14 which may be a plasma display, computer monitor or the like. As shown in FIG. 1, the display 14 is embodied as a display incorporated into the music stand 16 for the piano 12. Alternatively, the display 14 may be incorporated into a housing which can be clipped onto the music stand 16 or into a separate display 14 which may be positioned in the place of the music stand 16 or positioned behind or to either side of the stand 16. Suffice it to say the display 14 is positioned to be viewed by a person seated at the piano 12 at a convenient and natural position to play the same.

The piano 12 may be an electrical or acoustical piano and includes a keyboard 18, legs 20 and pedals 22 as is well known in the art.

The system 10, to control the display 14, includes a computer processor 24 in communication with the display 14 by a communication cable 26 or as by being incorporated therein. If desired, wireless communication may be employed as well to put the processor in communication with the display for control thereof. The processor 24 is preferably a personal computer or dedicated processor. The processor 24 not only controls and drives the display 14 but also controls speakers 28 and a digital camera 30 mounted to scan the person playing the piano 12. The speakers 28 may also include microphones to pick up the piece as being played or sung for rebroadcast or archiving thereof.

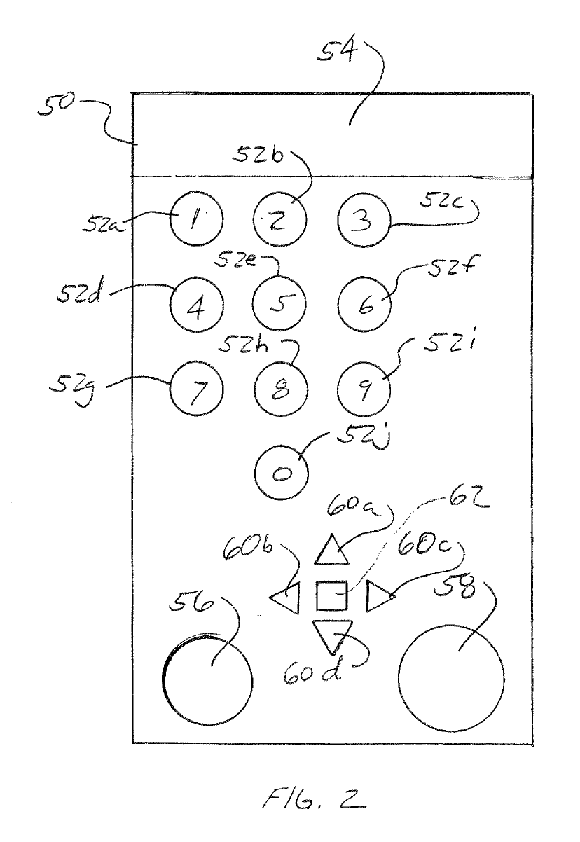

The processor 24 controls the display 14 to display music score, tutorial information, operational instructions, video images and the like as hereinafter described. A controller data input device 32 such as a keyboard, keypad 50 on the cheek block 33, mouse or touch screen enables the user of the system 10 to control the processor 24 and other features of the system 10. With reference to FIG. 2, a cheek block keypad 50 for the system 10 is shown. The keypad 50 is shown by way of example only in that other controller data input devices could be used.

The keypad 50 is in communication with the processor 24 and has numbered buttons 52a-j which may be numbered 0 through 9 for sending number or letter signals to the processor 24. Also provided on the keypad 50 is a display 54 to display information from the processor 24 and to be sent to the processor. The display 54 may be any suitable type of display. A touch pad 56 disposed at a convenient location for the user is provided to input various prompts to the processor 24 such as to turn to the next page of music displayed, to change the key of the music or to perform any desirable function at the touch of a finger. Instead of using the keypad 50, the pedals 22 may be connected to suitable switches to signal the processor 24 to turn the page. A track ball 58 enables the user to position a cursor on the display 14 for controlling the system in the fashion of a mouse. Arrow keys 60a-d as well as an Enter button 62 also enable the user to control, through the processor 24, the display 14. For example, a student using arrow key 60a may scroll in a reverse direction the music displayed at the display 14 to replay a passage of music. Alternatively, the arrow keys 60a-d may be enabled to speed up or slow down the pace of the musical piece, to increase the font/note size of the material display at display 14 or to increase/decrease the brightness of the display 14, which may be of benefit to those that are visually impaired. The touch pad 56 may also be used to pause the scrolling or playing of the piece or to mute the transmission of audio signals.

Also included is a printer/scanner 34 connected to the processor 24 to print data from the system into a paper form or to scan in text/music for storage and retrieval. The processor 24 further includes a modem or other Internet interface to enable the processor 24 to communicate over the Internet 36. As shown, the processor 24 is adapted to read/write onto data storage media such as compact discs 38 and/or floppy discs 40, digital video disks, laser discs or any other data storage media.

Autoplay Mode

If the piano 12 is capable of being configured into a self-playing or player piano, data storage media such as floppy disks, CD-Rom, DVD or the like may be read by the processor 24 which controls the piano 12 keys 18 or speaker 28 or headset (not shown) to play music. Additionally, through the connection to the Internet 36 music or key control data may be read in real time or downloaded for future play.

In Tutorial Mode

In the tutorial mode, the system 10 is adapted to display at the display 14 music scores and/or instructional text selected by the operator to play. The scores can be retrieved from the memory of the processor 24, from data storage media such as the discs 38, 40 or downloaded from the Internet 36. The music as downloaded or as controlled by the processor 24 may include features such as timing of the piece, i.e. metronome settings, key or fingering which the operator can manipulate to slow down or speed up the tempo of the piece, to select the key of the piece or transpose the key or to show or alter the fingering or show alternative fingering. Thus the system 10 can display at the display 14 music for the person to play.

The system 10 in regards to displaying music, can also display lesson music, practice pieces, scales and the like. In real time, if desired, the person can send through the Internet 36 the music being played by virtue of the microphones. Thus the instructor may be in another country and still send lessons in one or both of audio and visual and hear the lessons being played. These lessons may be written or audio as transmitted over the Internet 36 Also, the lessons as played can be captured by the camera 30 and transmitted as well so the instructor can see posture, fingering of the piece and the like. Further, the processor 24 can be programmed to control the display 14 to show different views such as a segment of the display 14 (or window) showing the musical score and another segment showing live streaming video or recorded video of the performance or instructors commands.

Still further, in connection with a piece being transmitted or accessed, the audio of how the piece should sound can also be reproduced at the speakers 28. Thus, where the instrument is a piano, the person may access a Bach piece through the Internet 36 to be displayed at the display 14. Further, prior to playing the piece, an audio track of the piece as played by a professional is played at the speakers 28 so the user can hear how the piece should sound. Video may also be downloaded and displayed at the display 14 so the user can see the professional performance.

Still further, in addition to transmitting the lesson or other performance, the lesson may be recorded in any audio storage format for later reproduction or to transmit via the Internet 36 to another. Additionally, particularly where the piano is an electronic piano, a keystroke counter may be provided and the data stored so that instructors can confirm that the student has been practicing.

As can be appreciated, depending upon the proficiency level of the student or performer, the nature and type of music retrieved and displayed for play or for a lesson plan can be selected. Further, in regards to downloading music through the Internet 36, the scores may indicate whether the piece is a beginner, intermediate or advanced level piece.

Thus, the system 10 enables the user to access a large library of music without having to acquire sheet music and music books, can take lessons from an instructor anywhere in the world through the Internet 36 and can send and receive video and audio portions of a performance.

Performance Mode

The system 10 is particularly adapted to enable the user to select and play music from the memory of the processor 24, from data storage media or retrieved through the Internet 36. The user can select the level or difficulty of the score selected, can provide a catalog for favorite pieces and, particularly where the music is downloaded from the Internet 36, can bookmark source sites or favorite pieces.

Accompaniment Mode

Another feature of the system 10 of the present invention is that the user can download music as well as an audio (as well as video) accompaniment. Thus, the user can download a Bach piece and the orchestral accompaniment to be played through the speakers 28 as the user plays the piano part for the piece. Thus the user can play with bands, orchestras and the like for fun and enjoyment. This aspect may also be useful in teaching.

Still further, through the camera 30, microphones and speakers 28 the user can play, in real time, in a band or orchestra by receiving the sounds and video of the other members of the ensemble and transmitting his video and audio for his part through the Internet 36. The live play can be saved to discs 38, 40 or in any suitable audio or audio/visual format.

The creation of a piece with other remote band members can also be done piecemeal with each member performing their part in sequence and the following performers blending their parts for the piece.

Composing

In the composing mode, the user can compose music by writing the same using the input device 32 or, where the instrument is, for example, an electric piano or synthesizer, directly inputting the score from the keyboard 18. Additionally or alternatively, the keypad 50 keys 52a-h may also have letters corresponding to notes of the scale with the arrows 60a-d used to transpose key and octave. The created score and any related tutorial or other instructions or notes can then be sent via the Internet 36 to another to be played or commented upon, embellished or used to write accompaniment music. Where the musical instrument is acoustical, the processor 24 may be programmed to have sound recognition to transcribe the music as played.

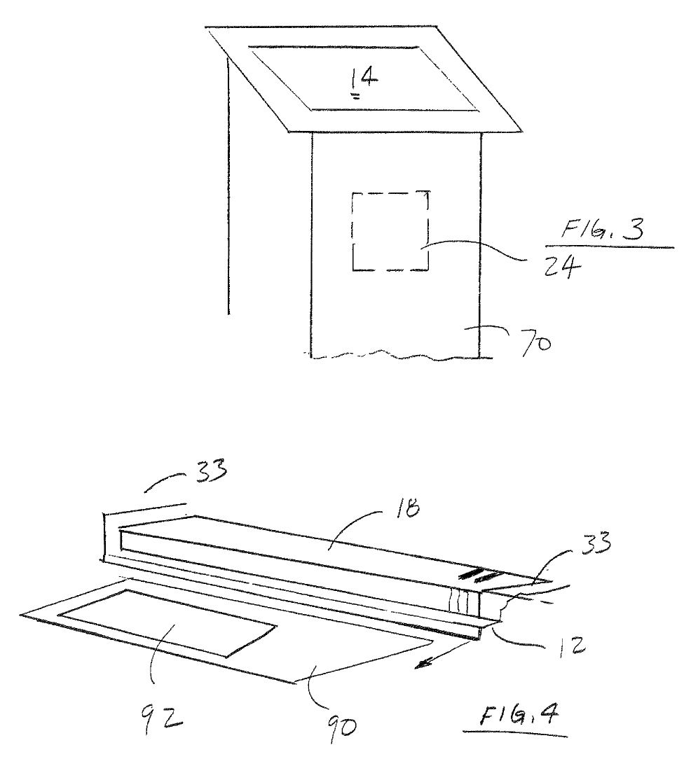

The system 10 is also adapted for instruments other than keyboard instruments. For example, the display 14 and processor 24 could be incorporated into a conductors stand 70 (FIG. 3) or into a music stand or any instrument for the display of score, notes and the like.

The processor 24 can also be used to transpose score, change octaves and the like. The score changed, can be score that has been scanned, downloaded or saved.

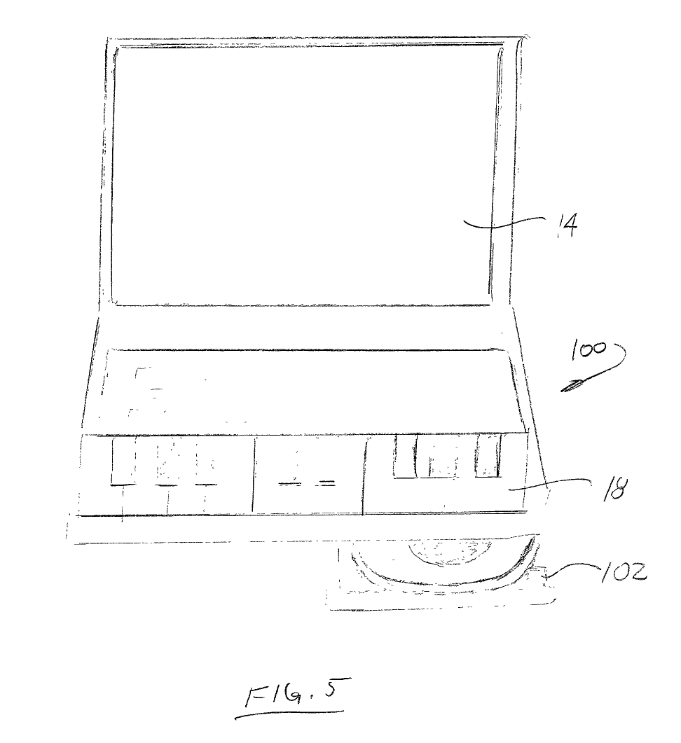

With reference to FIG. 4, the keys 18 are shown with the cheek blocks 33 for a key board instrument such as a piano 12. Mounted beneath the keys 18 is a tray 90 which can be slid forward to reveal the input device such as a wireless keyboard 92. The tray 90 may also include other accessories such as a telephone, radio, a headset or the like.

Other Features

Turning to FIG. 5, there is shown a laptop 100 configured to have the display 14 and data entry means such as a keyboard as well as including keys 18 and means for reading stored data such as a CD-Rom drive 102 and the like. By cable connection with the laptop 100 the user can interface with the Internet 36 or with other processors, such as processor 24. By using the keys 18 the user can play score displayed at display 14 (listening through the laptop 100 speakers or headphones) as well as compose, retrieve and display score at display 14 and play tutorials and the like in the manner described above. The keys 18, instead of being a separate structure, could be embodied as a set of keys 18 which are coupled to a standard laptop to overlay the laptop keyboard and by reprogramming the key functions of the laptop such that depressing of the keys 18 creates the notes of the scale corresponding to the keys of a piano.

Another feature is that the data storage media, such as the floppy disk or CD can store data corresponding to musical score. A user would load the CD or disk in a reading device and would access and display score stored thereon for the user to play the music.

While we have shown and described certain embodiments of the present invention it should be understood that it is subject to many modifications without departing from the spirit and scope of the appended claims.

We claim:

1. An interactive system for providing for musical training and performance comprising:
a display;
a processor;
a data structure storing a plurality of music composition data files including at least music, each of said files adapted to be modified to change at least tempo and key; and
a controller to control the processor to access a selected file in the data structure and to display the same at the display, said controller further including means to modify the displayed data for at least one of changing said tempo and key and for scrolling the display to display said musical file.

2. The system of claim 1 said data structure further including data for each file corresponding to audio performance of the music and speakers, said controller including means to control the processor to retrieve for a file said performance data and control the speakers to provide audio of the music.

3. The system of claim 1 further comprising a telecommunications link between said processor and a remote data structure storing said files.

4. The system of claim 1 further comprising processor readable media having computer readable program code means embodied therein storing said data files.

5. The system of claim 1 further comprising said data structure stores accompaniment data representing an audio accompaniment, speakers controlled by said processor, and said controller including means to access and retrieve for a music file said music for display of the same at the display for performance of the same and data to control said processor to control said speakers to broadcast said audio accompaniment in coordination with said music data.

6. The system of claim 1 wherein said data storage files further include tutorial text for display at said display.

7. An improved electronic keyboard of the type having keys, a keyboard processor, on-board music data storage means and a speaker, the improvement comprising:
a display;
a system processor;
a data structure storing a plurality of music composition data files including at least music, keyboard processor control data to control the keyboard speakers to broadcast a performance of the music, each of said files adapted to be modified to change at least tempo and key; and
a controller to control the processor to access a selected file in the data structure and to display the same at the display, said controller further including means to modify the displayed data for at least one of changing said tempo and key, for scrolling the display to display said musical file and access said processor control data and provide the same to the keyboard processor to broadcast a performance of the music.

8. The system of claim 7 further comprising a telecommunications link between said processor and a remote data structure storing said files.

9. The system of claim 8 said controller further comprising means to control said processor to transfer data stored in the on-board data structure to said remote data structure.
